(19) United States
(12) Patent Application Publication
(10) Pub. No.: US 2018/0374098 A1
(43) Pub. Date: Dec. 27, 2018

(54) Modeling method and device for machine learning model

(71) Applicant: ALIBABA GROUP HOLDING LIMITED, George Town (KY)

(72) Inventors: Ke ZHANG, Hangzhou (CN); Wel CHU, Hangzhou (CN); Xing SHI, Hangzhou (CN); Shukun XIE, Hangzhou (CN); Feng XIE, Hangzhou (CN)

(73) Assignee: ALIBABA GROUP HOLDING LIMITED

(21) Appl. No.: 15/999,073

(22) Filed: Aug. 17, 2018

Related U.S. Application Data
(63) Continuation of application No. PCT/CN2017/073023, filed on Feb. 7, 2017.

(30) Foreign Application Priority Data
Feb. 19, 2016 (CN) 201610094664.8

(51) Int. Cl. G06Q 20/40; G06F 15/18; G06F 17/11; G06F 17/18; G06K 9/62

(52) U.S. Cl. CPC G06Q 20/4016; G06F 15/18; G06K 9/6256; G06F 17/18; G06F 17/11

(57) ABSTRACT

There is provided a modeling method and device for a machine learning model. A machine learning sub-model corresponding to each intermediate target variable is trained to obtain a probability value of the machine learning sub-model. The probability values of the machine learning sub-models are summed to obtain a target probability value. A target machine learning model for determining a target behavior is established according to the target probability value and feature variables for describing transaction behaviors.

### CROSS-REFERENCE TO RELATED APPLICATION

This application is a continuation of International Application No. PCT/CN2017/073023, filed on Feb. 7, 2017, which is based upon and claims priority to Chinese Patent Application No. 201610094664.8, filed on Feb. 19, 2016, both of which are incorporated herein by reference in their entireties.

### TECHNICAL FIELD

The present disclosure relates to computer technologies, and in particular, to modeling methods and devices for a machine learning model.

### BACKGROUND

To determine a behavior pattern by using a machine learning model, common features are generally extracted from various specific behaviors belonging to a certain target behavior, and a machine learning model is constructed according to the common features. The constructed machine learning model determines whether a specific behavior belongs to the target behavior according to whether the specific behavior has the common features.

Fraudulent transactions occur in a network, and there is a need to recognize fraudulent transactions using machine learning models. A fraudulent transaction refers to a behavior of a seller user and/or a buyer user acquiring illegal profits (e.g., fake commodity sales, shop ratings, credit points, or commodity comments reviews) in illegal manners such as by making up or hiding transaction facts, evading or maliciously using a credit record rule, and interfering or obstructing a credit record order. For example, there are fraudulent transaction types such as order refreshing, credit boosting, cashing out, and making fake orders and loans. The behavior pattern of fraudulent transactions needs to be determined to regulate network transaction behaviors.

There are various types of fraudulent transactions. Each type of fraudulent transactions can be implemented in various specific manners, and transaction behaviors of various types of fraudulent transactions differ from one another. Conventionally, it is difficult to construct a machine model for determining fraudulent transactions by extracting common features. Therefore, conventionally, a machine learning model is used to determine a specific implementation form or a specific type of fraudulent transactions. Thus, multiple machine learning models need to be established to recognize different forms or types of fraudulent transactions. This leads to high costs and low recognition efficiency.

### SUMMARY

The present disclosure provides examples of a modeling method and device for a machine learning model to construct a machine learning model to determine target behaviors when the target behaviors have many different types of implementation forms. The examples provided herein can save costs and improve the recognition efficiency.

In accordance to some embodiments of the disclosure, there is provided a modeling method for a machine learning model. The method includes training a plurality of machine learning sub-models to obtain a probability value for each of the plurality of machine learning sub-models. The method also includes obtaining a target probability value based on probability values of the machine learning sub-models obtained from the training of the plurality of machine learning sub-models. The method further includes establishing, according to the target probability value and feature variables, a target machine learning model for determining a target behavior.

In accordance to some embodiments of the disclosure, there is provided a modeling device for a machine learning model. The device includes a training module configured to train a plurality of machine learning sub-models obtain a probability value for each of the plurality of machine learning sub-models. The device also includes a summing module configured to obtain a target probability value based on probability values of the plurality of machine learning sub-models obtained by the training module. The method further includes a modeling module configured to establish, according to the target probability value and feature variables, a target machine learning model for determining a target behavior.

In accordance with some embodiments of the disclosure, there is provided a non-transitory computer-readable storage medium storing a set of instructions that is executable by one or more processors of an electronic device to cause the electronic device to perform a modeling method for a machine learning model. The method is performed to include training a plurality of machine learning sub-models to obtain a probability value for each of the machine learning sub-models. The method is performed to also include obtaining a target probability value based on probability values obtained from the training of the plurality of machine learning sub-models. The method is performed to further include establishing, according to the target probability value and feature variables, a target machine learning model for determining a target behavior.

In the modeling method and device for a machine learning model provided in some embodiments of the present disclosure, each of a plurality of machine learning sub-models corresponding to an intermediate target variable is trained to obtain a probability value of the machine learning sub-model. Then, the probability values of the machine learning sub-models are summed to obtain a target probability, and a target machine learning model for determining a target behavior is established according to the target probability value and feature variables for describing transaction behaviors. As each machine learning sub-model is used for determining a particular type of a target behavior, and the probability values of the machine learning sub-modules are summed to obtain a probability that a sample includes at least one type of multiple target behavior types, a machine learning model constructed based on the probability values can be used for determining a target behavior. For example, if the modeling method is applied to a scenario in which fraudulent transactions occur, the constructed model can determine the fraudulent transactions, and it may be unnecessary to construct multiple models for different implementation forms or types of fraudulent transactions. Thus, costs can be saved, and fraudulent transactions can be efficiently recognized.

### BRIEF DESCRIPTION OF THE DRAWINGS

The accompanying drawings are used to facilitate understanding of the present disclosure and constitute a part of the present disclosure. The exemplary embodiments are not intended to limit the scope of present disclosure. In the drawings:

FIG. 1 is a flowchart of a modeling method for a machine learning model according to some embodiments of the present disclosure;

FIG. 2 is a flowchart of a modeling method for a machine learning model according to some embodiments of the present disclosure;

FIG. 3 is a schematic diagram illustrating a process for reconstructing a target variable according to some embodiments of the present disclosure;

FIG. 4 is a block diagram of a modeling device for a machine learning model according to some embodiments of the present disclosure; and

FIG. 5 is a block diagram of a modeling device for a machine learning model according to some embodiments of the present disclosure.

### DETAILED DESCRIPTION

Exemplary embodiments of the disclosure are described below in more detail with reference to the accompanying drawings. The exemplary embodiments of the disclosure are shown in the accompanying drawings in which identical reference numerals are used to indicate identical elements throughout the accompanying drawings. It should be understood that the disclosure may be implemented in various forms and should not be limited by the embodiments described here. The embodiments are provided for those skilled in the art to understand the disclosure more thoroughly, and can facilitate conveying the scope of the disclosure to those skilled in the art.

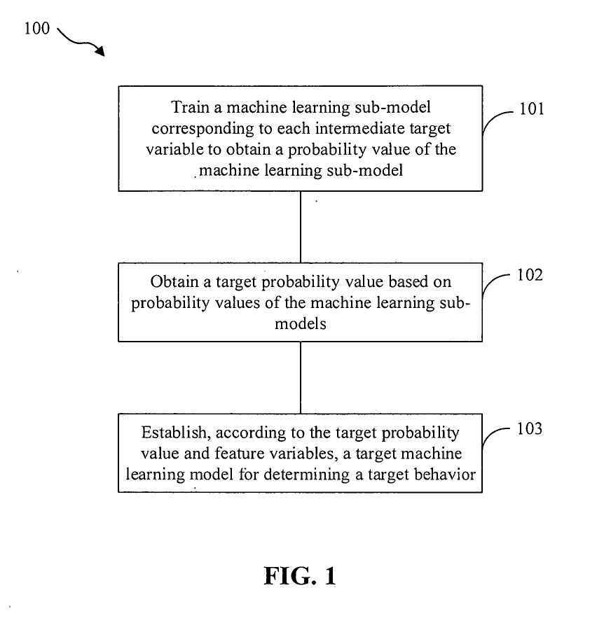

FIG. 1 is a flowchart of a modeling method 100 for a machine learning model according to some embodiments of the present disclosure. The method 100 can be used for determining fraudulent transactions. For example, a target behavior described in method 100 may include a fraudulent transaction. The method 100 may be further applicable to other abnormal transactions, which is not limited by these embodiments. As shown in FIG. 1, the method 100 includes the following steps.

In step 101, a machine learning sub-model corresponding to each intermediate target variable is trained to obtain a probability value of the machine learning sub-model. The machine learning sub-model may be used for determining a target behavior type indicated by the corresponding intermediate target variable according to a feature variable describing a transaction behavior.

In some embodiments, implementation forms having similar transaction behaviors for a target behavior may be classified into one type, such that the transaction behaviors in each type are similar. Transaction behaviors of different types are usually very different from one another. For example, in a scenario in which fraudulent transactions are to be determined, the fraudulent transactions have various implementation forms such as order refreshing, cashing out, loan defrauding, and credit boosting. Among these implementation forms, transaction behaviors of credit boosting and order refreshing are relatively similar and can be classified into the same type, while transaction behaviors of cashing out and loan defrauding are relatively different and can be each used as a separate type.

Initial target variables are used for indicating specific implementation forms of a target behavior. When classification of types is performed for a target behavior, initial target variables that are compatible may be combined to obtain intermediate target variables that are in a mutually exclusive state, according to compatible or mutually exclusive states among the initial target variables. If transaction behaviors of different implementation forms have relatively large differences, initial target variables corresponding to the different implementation forms may be mutually exclusive. If transaction behaviors of different implementation forms have relatively small differences, initial target variables corresponding to the different implementation forms may be compatible.

A machine learning sub-model corresponding to each intermediate target variable is constructed. The machine learning sub-model may be a binary model for determining whether a sample belongs to a target behavior type indicated by a corresponding intermediate target variable, according to a feature variable for describing a transaction behavior. The machine learning sub-models are trained by using training samples to obtain probability values of the machine learning sub-models.

In step 102, a target probability value is obtained based on the probability values of the machine learning sub-models. For example, the target probability value may be a sum of the probability values of the machine learning sub-models. As each machine learning sub-model is used for determining a target behavior type indicated by the corresponding intermediate target variable, the probability values of the machine learning sub-models can be summed to obtain a probability for determining at least one of the multiple target behavior types, i.e., the target probability value.

In step 103, a target machine learning model for determining a target behavior is established according to the target probability value and the feature variables. For example, the target machine learning model may be a binary model. The probability of the target machine learning model may be the target probability value. An input of the target machine learning model includes a feature variable for describing a transaction behavior, and an output of the target machine learning model includes a target variable for indicating whether the transaction behavior is a target behavior. A value of the target variable may be 0 or 1. When the value of the target variable is determined as 1 according to a feature variable of a sample, the sample is a positive sample, i.e., the sample belongs to a target behavior; otherwise, the sample is not a target behavior.

In the method 100, a machine learning sub-model corresponding to each intermediate target variable is trained to obtain a probability value of the machine learning sub-model. Then, a target machine learning model for determining a target behavior is established according to a target probability value obtained based on the probability values of the machine learning sub-models and feature variables for describing transaction behaviors. In a scenario in which fraudulent transactions are to be determined, the target behavior may be a fraudulent transaction. Therefore, each machine learning sub-model is used for determining a type of a fraudulent transaction indicated by a corresponding intermediate target variable. A probability for determining at least one of multiple fraudulent transaction types can be obtained by summing the probability values of the machine learning sub-models. A model constructed based on the obtained probability thus can determine various fraudulent transaction types. In doing so, costs can be saved and the recognition efficiency of fraudulent transactions can be improved.

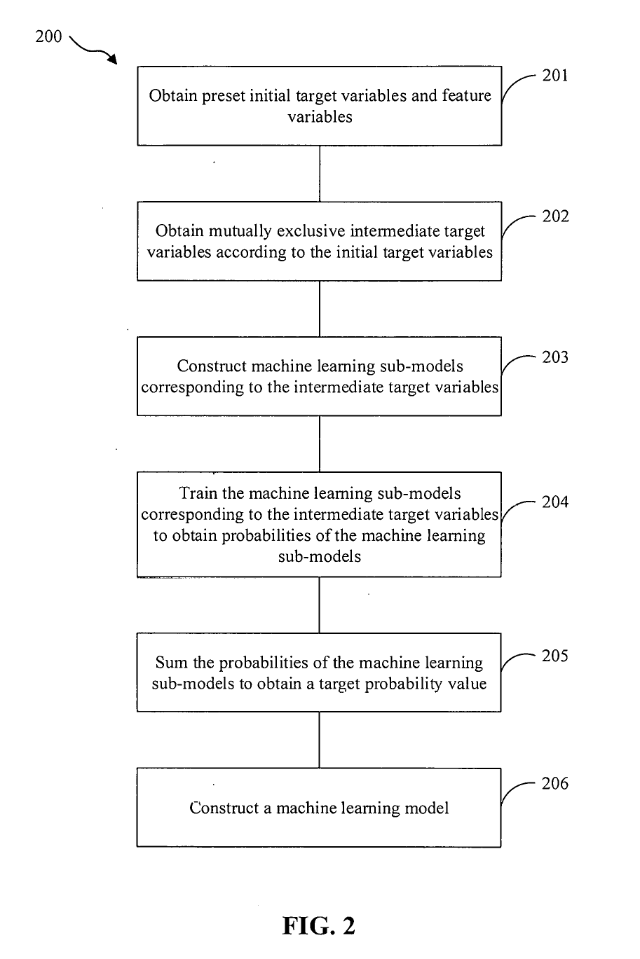

FIG. 2 is a flowchart of a modeling method 200 for a machine learning model according to some embodiments of the present disclosure. In the description of FIG. 2, constructing a machine learning model for determining fraudulent transactions is used as an example to further describe the technical solution in the embodiments of the present disclosure. As shown in FIG. 2, the method 200 includes the following steps.

In step 201, preset initial target variables and feature variables are obtained. For example, transaction records from historical transactions are recorded as historical transaction data. Each transaction record includes transaction information in three dimensions, respectively being buyer transaction information, seller transaction information, and commodity transaction information. In addition, each transaction record further includes information indicating whether the transaction belongs to specific implementation forms of various fraudulent transactions. The specific implementation forms of a fraudulent transaction include, but are not limited to, order refreshing, cashing out, loan defrauding, and credit boosting.

In some embodiments, a parameter for describing transaction information and a parameter for describing the type of a fraudulent transaction may be extracted from the historical transaction data, which are set as a feature variable x and an initial feature variable y respectively.

For example, order refreshing may be used as an initial feature variable y₁; cashing out may be used as an initial feature variable y₂; loan defrauding may be used as an initial feature variable y₃; and credit boosting may be used as an initial feature variable y₄.

As historical information includes a large number of parameters, a user can extract as many parameters for describing transaction information as possible and use them as feature variables when setting the feature variables. By extracting more complete transaction information, the transaction behaviors described by the feature variables become more accurate. When an analysis operation such as classification is conducted by using a machine learning model established accordingly, a result obtained can be more accurate.

In step 202, mutually exclusive intermediate target variables are obtained according to initial target variables. In some embodiments, compatible or mutually exclusive states among the initial target variables are determined. According to the compatible or mutually exclusive states among the initial target variables, compatible initial target variables are merged to obtain intermediate target variables in a mutually exclusive state.

First, compatible or mutually exclusive states among the initial target variables are determined according to a formula:

$$\{ \begin{matrix}\frac{{Num}_{ij}}{{Num}_{i }} < {T}_{1} and \frac{{Num}_{ij}}{{Nim}_{j}} < {T}_{2} , & {H}_{ij} = 1 \\ Otherwise , & {H}_{ij} = 0\end{matrix} ,$$

wherein Numᵢⱼ denotes the number of transaction records defined as positive samples in historical transaction data by both an initial target variable yᵢ and an initial target variable yⱼ, Numᵢ denotes the number of transaction records defined as positive samples in the historical transaction data by initial target variable yᵢ, Numⱼ denotes the number of transaction records defined as positive samples in the historical transaction data by initial target variable yⱼ, and ranges of i and j are 1≤i≤N and 1≤j≤N, N being the total number of initial feature variables. Two initial target variables are mutually exclusive when H=1, and two initial target variables are compatible when H=0. T₁ and T₂ are preset thresholds, 0<T₁<1, and 0<T₂<1. In some implementations, T₁=T₂=0.2. In addition, 0.2 in the above formula is merely an example threshold. In actual use, another value may be selected. The lower the value of the threshold is, the two initial target variables determined when H=1 are more strictly mutually exclusive to each other. In other words, the influence of one initial target variable on the value of the other initial target variable becomes smaller. Every two initial target variables in a mutually exclusive state are used as an initial target variable pair.

In this disclosure, a positive sample refers to that a transaction record belongs to a fraudulent transaction type indicated by an initial target variable, and a negative sample refers to that a transaction record does not belong to a fraudulent transaction type indicated by an initial tai get variable. Being mutually exclusive refers to that the value of one initial target variable has small influences on the value of the other initial target variable. Being compatible refers to that the value of one initial target variable has large influences on the value of the other initial target variable.

Next, a split set is constructed to include all initial target variables. Then, the step of splitting the split set into two next-level split sets according to an initial target variable pair is performed repeatedly. The next-level split set is used for conducting splitting according to a next initial target variable pair, until splitting is conducted for all the initial target variable pairs. Each split set includes an initial target variable in an initial target variable pair, and all but the elements of the initial target variable pair in the split set are being split. Split sets having a mutual inclusion relationship are merged to obtain a target subset. Initial target variables in a same target subset are merged as an intermediate target variable Y.

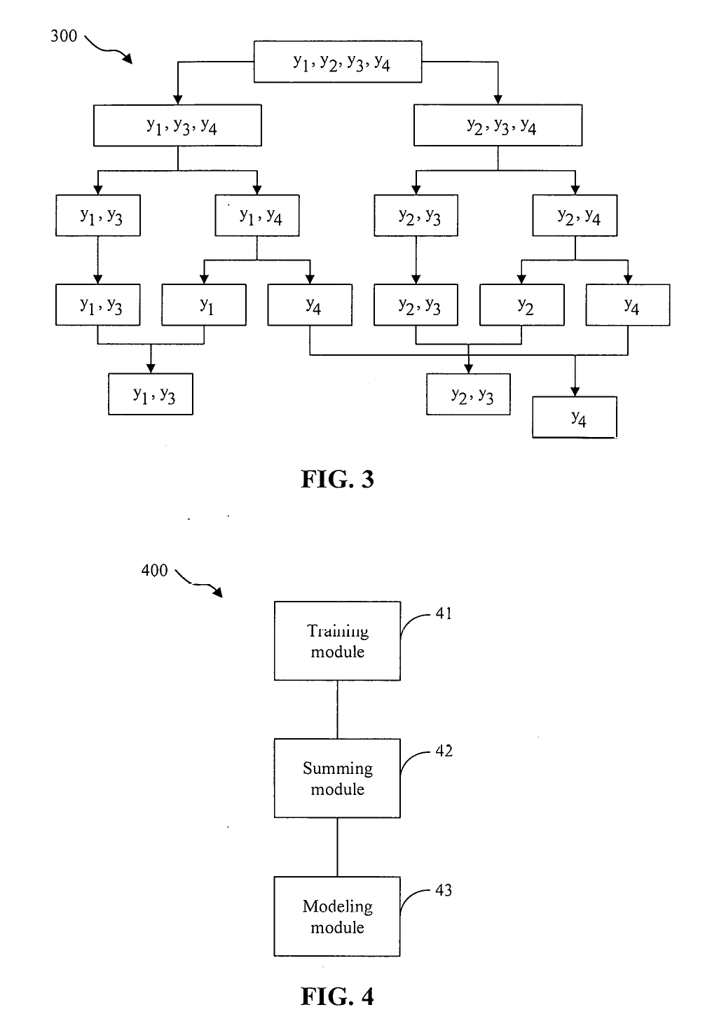

For example, if initial target variables are y₁, y₂, y₃, and y₄, and if it is determined through calculation that an initial target variable pair y₁ and y₂, an initial target variable pair y₁ and y₄, an initial target variable pair y₂ and y₄, and an initial target variable pair y₃ and y₄ each have a mutually exclusive relationship, a reconstruction process of splitting and merging may be conducted accordingly on a split set {y₁, y₂, y₃, y₄}. FIG. 3 is a schematic diagram illustrating a process 300 of reconstructing target variables. As shown in FIG. 3, obtained target subsets are {y₁, y₃}, {y₂, y₃}, and {y₄}. Variables y₁ and y₃ are merged as Y₁, y₂ and y₃ are merged as Y₂, and y₄ is taken as Y₃.

In step 203, machine learning sub-models corresponding to the intermediate target variables are constructed. In some embodiments, a binary machine learning sub-model is constructed for each intermediate target variable. The machine learning sub-model of an intermediate target variable is used for determining whether a sample is a positive sample of the intermediate target variable.

In some embodiments, where the machine learning sub-model is a linear model, feature variables may be screened for the machine learning sub-model of an intermediate target variable in order to improve the performance of the machine learning sub-model and reduce training noise during training of the machine learning sub-model. The feature variables of each machine learning sub-model after the screening may be different. Feature variables that are unidirectional are kept in each machine learning sub-model to avoid training noise caused by inconsistent directions of the feature variables. In some embodiments, the screening process includes determining a covariance between each feature variable and each initial target variable that is used for merging to obtain an intermediate target variable, and screening out feature variables having covariances of inconsistent directions with the initial target variables.

For example, the feature variables include X₁, X₂, . . . , X_{q} . . . , and Xₙ, where n is the total number of the feature variables. The intermediate target variables include Y₁, Y₂, . . . , Yᵥ . . . , and Y_{N′}, where N′ is the total number of the intermediate target variables.

The initial target variables that are merged to obtain intermediate target variable Yᵥ are denoted as yₛ. In a machine learning sub-model of intermediate target variable Yᵥ, a covariance between each feature variable X_{q} and each initial target variables yₛ may be determined by using the formula:

Cov_{qs}=Σₛₖ(X_{qk}−X̅_̅{̅q̅}̅)(vₛₖ+y̅ₛ̅),

where 1≤q≤n, 1≤s≤S, S is the number of initial target variables yₛ that are merged to obtain intermediate target variable Yᵥ, X_{q}k is a value of a feature variable X_{q} in the V′ transaction record in historical transaction data, yₛk is a value of an initial target variable yₛ in the k^{th} transaction record in the historical transaction data, X_{q} is an average value of feature variables X_{q} in the historical transaction data, and y̅ₛ̅ is an average value of initial target variables yₛ in the historical transaction data. If the calculated covariance feature variables Cov_{q1}, Cov_{q2}, . . . , Cov_{qs} have the same sign, feature variable X_{q} is kept. If the calculated covariance feature variables Cov_{q1}, Cov_{q2}, . . . , Cov_{qs} do not have the same sign, feature variable X_{q} is screened out.

A machine learning sub-model M of an intermediate target variable Y is then constructed. The input of the machine learning sub-model M is the feature variable X after the screening, and the output is the intermediate target variable Y.

In step 204, the machine learning sub-models corresponding to the intermediate target variables are trained to obtain probabilities of the machine learning sub-models. For example, each transaction record in the historical transaction data is used as a training sample. The machine learning sub-models are trained by using a training sample set constructed from the historical transaction data to obtain a probability Pᵥ of a machine learning sub-model.

To obtain better performance of the simulation training of the machine learning sub-models, each transaction record in the historical transaction data may be copied according to weights of the initial target variables that are merged to obtain the intermediate target variables corresponding to the machine learning sub-models. The copied historical transaction data is used as a training sample set. The training sample set of each machine learning sub-model may be constructed in this manner.

The weight is used for indicating the importance of the initial target variable. Thus, the more important the initial target variable is, the larger the number of positive samples of the initial target variable in the training sample set obtained after the copying operation becomes. Thus, the training simulation performance during the training can be improved.

For example, when a training sample set is constructed for a machine learning sub-model of intermediate target variable Yᵥ, weights of initial target variables yₛ that is merged to obtain intermediate target variable Yᵥ are predetermined as W₁, W₂, . . . , Wₛ, . . . , W_{S}. For each transaction record, the number of copies CN can be determined according to the following formula:

CN=1+Σₛ₌₁^{S}Wₛyₛ.

If the training sample is a positive sample of the initial target variable yₛ, yₛ=1. If the training sample is a negative sample of the initial target variable yₛ, yₛ=0. Thus, the number of the copied samples CN is obtained. Corresponding CN copies are made for each training sample to construct a training sample set.

Then, the machine learning sub-models corresponding to the intermediate target variables are trained respectively to obtain probabilities P₁, P₂, . . . , Pᵥ, . . . , and P_{N′} of the machine learning sub-models by using the training sample set obtained by copying.

In step 205, the probabilities of the machine learning sub-models are summed to obtain a target probability value. For example, to calculate and obtain a probability P of the machine learning model, the following formula may be used:

P=1−Σᵥ₌₁^{N′}(1−pᵥ), where p₁, p₂, . . . , pᵥ, . . . , and p_{N′} are the probabilities of the machine learning sub-models.

In step 206, a machine learning model is constructed. In some embodiments, the machine learning model is a binary model. The probability of the machine learning model is P. The input is the feature variable X, and the output is the target variable for indicating whether a transaction is a fraudulent transaction. The constructed machine learning model is used for determining whether a transaction behavior described by the input feature variable belongs to a fraudulent transaction. Whether a sample is a fraudulent transaction may be determined using the machine learning model. If the sample is determined as a positive sample, it indicates that the probability of a transaction indicated by the sample being a fraudulent transaction is high. If the sample is determined as a negative sample, it indicates that the probability of a transaction indicated by the sample being a fraudulent transaction is low.

FIG. 4 is a block diagram of a modeling device 400 for a machine learning model according to some embodiments of the present disclosure. As shown in FIG. 4, the modeling device 400 includes a training module 41, a summing module 42, and a modeling module 43.

Training module 41 is configured to train a machine learning sub-model corresponding to each intermediate target variable to obtain a probability value of the machine learning sub-model.

The machine learning sub-model is used for determining a target behavior type indicated by the corresponding intermediate target variable according to a feature variable describing a transaction behavior.

Summing module 42 is configured to sum the probability values of the machine learning sub-models to obtain a target probability value.

For example, summing module 42 may be configured to, obtain a probability P of a machine learning model using the following formula:

P=1 −Σᵥ₌₁^{N′}(1 −pᵥ),

where N′ is the number of the machine learning sub-models.

Modeling module 43 is configured to establish a target machine learning model for determining a target behavior, according to the target probability value and the feature variables.

In some embodiments, a machine learning sub-model corresponding to each intermediate target variable is trained to obtain a probability value of the machine learning sub-model. Then, the probability values of the machine learning sub-models are summed to obtain a target probability value, and a target machine learning model for determining a target behavior is established according to the target probability value and feature variables for describing transaction behaviors. In a scenario in which fraudulent transactions are to be determined, the target behavior may be a fraudulent transaction. Thus, each machine learning sub-model may be used for determining a fraudulent transaction type indicated by a corresponding intermediate target variable. A probability for determining at least one of multiple fraudulent transaction types can be obtained by summing the probability values of the machine learning sub-models. A model constructed based on the obtained probability thus can determine various fraudulent transaction types. In doing so, costs can be saved and the recognition efficiency of fraudulent transactions can be improved.

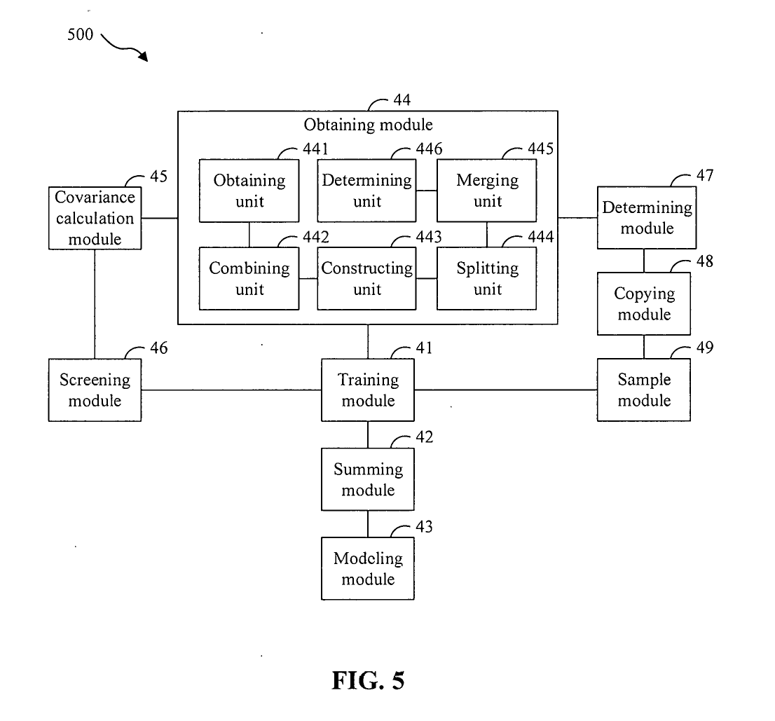

FIG. 5 is a block diagram of a modeling device 500 for a machine learning model according to some embodiments of the present disclosure. As shown in FIG. 5, in addition to the training module 41, summing module 42, and modeling module 43 provided in FIG. 4, the modeling device 500 further includes an obtaining module 44.

Obtaining module 44 is configured to merge compatible initial target variables to obtain intermediate target variables in a mutually exclusive state, according to compatible or mutually exclusive states among initial target variables. The initial target variable is used to indicate an implementation form of a target behavior.

The modeling device 500 for a machine learning model may be used to implement the method 400 described in the present disclosure. In some embodiments, the obtaining module 44 further includes an obtaining unit 441, a combining unit 442, a constructing unit 443, a splitting unit 444, a merging unit 445, and a determining unit 446.

Obtaining unit 441 is configured to determine compatible or mutually exclusive states among the initial target variables according to a formula:

$$\{ \begin{matrix}\frac{{Num}_{ij}}{{Num}_{i }} < {T}_{1} and \frac{{Num}_{ij}}{{Nim}_{j}} < {T}_{2} , & {H}_{ij} = 1 \\ Otherwise , & {H}_{ij} = 0\end{matrix} ,$$

where Numᵢⱼ denotes the number of transaction records defined as positive samples in historical transaction data by both an initial target variable yᵢ and an initial target variable yⱼ; Numᵢ denotes the number of transaction records defined as positive samples in the historical transaction data by initial target variable yᵢ; Numⱼ denotes the number of transaction records defined as positive samples in the historical transaction data by initial target variable yⱼ; and 1≤i≤N and 1≤j≤N, N being the total number of initial feature variables. The two initial target variables are mutually exclusive when H=1, and the two initial target variables are compatible when H=0.

T₁ and T₂ are preset thresholds, 0<T₁<1, and 0<T₂<1. In some embodiments, T₁=T₂=0.2.

Combining unit 442 is configured to construct an initial target variable pair for every two initial target variables in a mutually exclusive state.

Constructing unit 443 is configured to construct a split set including the initial target variables.

Splitting unit 444 is configured to perform, for each initial target variable pair, a step of splitting a split set into two next-level split sets according to the initial target variable pair. The splitting may be performed sequentially for each initial target variable pair. Each of the next-level split sets includes an initial target variable in the initial target variable pair and all elements in the split set are being split except the initial target variable pair. The next-level split set is used for conducting splitting according to a next initial target variable pair.

Merging unit 445 is configured to merge split sets having a mutual inclusion relationship as a target subset.

Determining unit 446 is configured to merge initial target variables in a same target subset to as the intermediate target variable.

In some embodiments, the machine learning sub-model is a linear model. The modeling device 500 further includes a covariance calculation module 45, a screening module 46, a determining module 47, a copying module 48, and a sample module 49.

Covariance calculation module 45 is configured to determine a covariance between a feature variable X_{q} and each initial target variable yₛ for each machine learning sub-model.

Initial target variable yₛ is used for merging to obtain the intermediate target variable corresponding to the machine learning sub-model.

Screening module 46 is configured to screen out feature variable X_{q} if signs of the covariances for feature variable X_{q} and each initial target variables yₛ are not the same and keep feature variable X_{q} if signs of the covariances for feature variable X_{q} and each initial target variables yₛ are the same.

Determining module 47 is configured to, for each transaction record, obtain a copy number CN using the following formula involving initial target variable yₛ and weight Wₛ of initial target variable yₛ:

CN=1+Σₛ₌₁^{S}Wₛyₛ,

where when the transaction record is a positive sample of the initial target variable yₛ, yₛ=1, and when the transaction record is not a positive sample of the initial target variable yₛ, yₛ=0, S being the number of the initial target variables yₛ.

Copying module 48 is configured to copy transaction records in the historical transaction data for each machine learning sub-model according to the copy number CN that is determined by a weight Wₛ of each initial target variable yₛ, where initial target variable yₛ is used for merging to obtain the intermediate target variable corresponding to the machine learning sub-model.

Sample module 49 is configured to use the copied historical transaction data as training samples of the machine learning sub-model.

The device 500 may be configured to execute the methods described in connection with FIG. 1 and FIG. 2, which will not be repeated here.

In some embodiments, a machine learning sub-model corresponding to each intermediate target variable is trained to obtain a probability value of the machine learning sub-model. Then, a target machine learning model for determining a target behavior is established according to a target probability value obtained based on the probability values of the machine learning sub-models and feature variables for describing transaction behaviors. In a scenario in which fraudulent transactions are to be determined, the target behavior may be a fraudulent transaction. Thus, each machine learning sub-model is used for determining a fraudulent transaction type indicated by a corresponding intermediate target variable. A probability for determining at least one of multiple fraudulent transaction types can be obtained by summing the probability values of the machine learning sub-models. A model constructed based on the obtained probability thus can determine various fraudulent transaction types. In doing so, costs can be saved and the recognition efficiency of fraudulent transactions can be improved.

Those of ordinary skill may understand that all or part of steps of the above described embodiments may be achieved through a program instructing related hardware. The program may be stored in a computer readable storage medium. When being executed, the program executes the steps of the above method embodiments. The storage medium includes various media that can store program codes, such as a ROM, a RAM, cloud storage, a magnetic disk, and an optical disc. The storage medium can be a non-transitory computer readable medium. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM any other memory chip or cartridge, and networked versions of the same.

The foregoing provides some exemplary embodiments of the present disclosure, and is not indented to limit the present disclosure. It should be appreciated that various improvements and modifications can be made, without departing from the principle of the present disclosure. Such improvements and modifications shall all fall within the scope of the present disclosure.

1. A modeling method for a machine learning model, comprising:
training a plurality of machine learning sub-models to obtain a probability value for each of the plurality of machine learning sub-models;
obtaining a target probability value based on probability values obtained from the training of the plurality of machine learning sub-models; and
establishing, according to the target probability value and feature variables, a target machine learning model for determining a target behavior.

2. The modeling method according to claim 1, wherein each of the plurality of machine learning sub-models corresponds to an intermediate target variable, the method further comprising:
before training the plurality of the machine learning sub-models, merging compatible initial target variables to obtain the intermediate target variables according to compatible or mutually exclusive states among initial target variables, the intermediate target variables being in a mutually exclusive state, wherein at least one of the initial target variables is used to indicate an implementation form of the target behavior.

3. The modeling method according to claim 2, wherein merging the compatible initial target variables comprises:
constructing an initial target variable pair for every two initial target variables in a mutually exclusive state;
constructing a split set comprising the initial target variables;
for each initial target variable pair, splitting a split set into two next-level split sets according to the initial target variable pair, each of the next-level split sets comprising an initial target variable in the initial target variable pair and one or more elements in the split set, wherein the next-level split set is used for conducting splitting according to a next initial target variable pair;
merging split sets having a mutual inclusion relationship to obtain a target subset; and
merging initial target variables in the target subset to obtain at least one of the intermediate target variables.

4. The modeling method according to claim 2, further comprising:
before merging the compatible initial target variables, determining compatible or mutually exclusive states between the initial target variables according to a formula:
$$\{ \begin{matrix}\frac{{Num}_{ij}}{{Num}_{i }} < {T}_{1} and \frac{{Num}_{ij}}{{Nim}_{j}} < {T}_{2} , & {H}_{ij} = 1 \\ Otherwise , & {H}_{ij} = 0\end{matrix}$$
wherein Numᵢⱼ is the number of transaction records defined as positive samples in historical transaction data by both an initial target variable yᵢ and an initial target variable yⱼ, Numᵢ is the number of transaction records defined as positive samples in the historical transaction data by initial target variable yᵢ, Numᵢ is the number of transaction records defined as positive samples in the historical transaction data by initial target variable yⱼ, 1≤i≤N, 1≤j≤N, N is the total number of initial feature variables, the two initial target variables are exclusive when H=1, the two initial target variables are compatible when H=0, T₁ and T₂ are preset thresholds, 0<T₁<1, and 0<T₂<1.

5. The modeling method according to claim 2, wherein at least one of the machine learning sub-models is a linear model, the method further comprising:
before training the plurality of machine learning sub-models, determining a covariance between a feature variable X_{q} and each initial target variable yₛ for the at least one of the machine learning sub-models, wherein the initial target variable yₛ is used to obtain the intermediate target variables; and
screening out the feature variable X_{q} if signs of the covariances between the feature variable X_{q} and each initial target variables yₛ are not the same and keeping the feature variable X_{q} if signs of the covariances between the feature variable X_{q} and each initial target variables yₛ are the same.

6. The modeling method according to claim 2, further comprising:
before training the plurality of machine learning sub-models, copying transaction records in the historical transaction data for each machine learning sub-model according to a copy number of transaction records determined by a weight Wₛ of each initial target variable yₛ, wherein the initial target variable yₛ is used to obtain the intermediate target variables; and
using the copied historical transaction data as training samples of the machine learning sub-model.

7. The modeling method according to claim 6, further comprising:
before copying the transaction records, obtaining a copy number of the transaction record based on a formula:
$$CN = 1 + {\sum }_{s = 1}^{S} {W}_{s} {y}_{s}$$
wherein CN is the copy number, S is the number of initial target variables yₛ, yₛ=1 when the transaction record is a positive sample of initial target variable yₛ, and, yₛ=0 when the transaction record is not a positive sample of initial target variable yₛ.

8. The modeling method according to claim 1, wherein obtaining the target probability value comprises:
determining a probability P of the machine learning model based on a formula:
$$P = 1 - {\sum }_{v = 1}^{{N}^{′}} ( 1 - {p}_{v} )$$
wherein Pᵥ is the probability value of the corresponding machine learning sub-model, and N′ is the number of the machine learning sub-models.

9. (canceled)

10. A modeling device for a machine learning model, comprising:
a training module configured to train a plurality of machine learning sub-models to obtain a probability value for each of the plurality of machine learning sub-models;
a summing module configured to obtain a target probability value based on probability values of the plurality of machine learning sub-models obtained by the training module; and
a modeling module configured to establish, according to the target probability value and feature variables, a target machine learning model for determining a target behavior.

11. The modeling device according to claim 10, wherein each of the plurality of machine learning sub-models corresponds to an intermediate target variable, the device further comprising:
an obtaining module configured to merge compatible initial target variables to obtain the intermediate target variables according to compatible or mutually exclusive states among initial target variables, the intermediate target variables being in a mutually exclusive state, wherein at least one of the initial target variables is used to indicate an implementation form of the target behavior.

12. The modeling device according to claim 11, wherein the obtaining module further comprises:
a combining unit configured to construct an initial target variable pair for every two initial target variables in a mutually exclusive state;
a constructing unit configured to construct a split set comprising the initial target variables;
a splitting unit configured to, for each initial target variable pair, split a split set into two next-level split sets according to the initial target variable pair, each of the next-level split sets comprising an initial target variable in the initial target variable pair and one or more elements in the split set, wherein the next-level split set is used for conducting splitting according to a next initial target variable pair;
a merging unit configured to merge split sets having a mutual inclusion relationship to obtain a target subset; and
a determining unit configured to merge initial target variables in the target subset to obtain at least one of the intermediate target variables.

13. The modeling device according to claim 11, wherein the obtaining module further comprises:
an obtaining unit configured to determine compatible or mutually exclusive states among the initial target variables according to a formula:
$$\{ \begin{matrix}\frac{{Num}_{ij}}{{Num}_{i }} < {T}_{1} and \frac{{Num}_{ij}}{{Nim}_{j}} < {T}_{2} , & {H}_{ij} = 1 \\ Otherwise , & {H}_{ij} = 0\end{matrix}$$
wherein Numᵢⱼ is the number of transaction records defined as positive samples in historical transaction data by both an initial target variable yᵢ and an initial target variable yⱼ, Numᵢ is the number of transaction records defined as positive samples in the historical transaction data by initial target variable yᵢ, Numⱼ is the number of transaction records defined as positive samples in the historical transaction data by initial target variable yⱼ, 1≤i≤N, 1≤j≤N, N is the total number of initial feature variables, the two initial target variables are exclusive when H=1, the two initial target variables are compatible when H=0, T₁ and T₂ are preset thresholds, 0<T₁<1, and 0<T₂<1.

14. The modeling device according to claim 11, wherein at least one of the machine learning sub-models is a linear model, and the device further comprises:
a covariance calculation module configured to determine a covariance between a feature variable X_{q} and each initial target variable yₛ for the at least one of the machine learning sub-models, wherein the initial target variable yₛ is used to obtain the intermediate target variables; and
a screening module configured to screen out the feature variable X_{q} if signs of the covariances between the feature variable X_{q} and each initial target variable yₛ are not the same and keep the feature variable X_{q} if signs of the covariances between the feature variable X_{q} and each initial target variable yₛ are the same.

15. The modeling device according to claim 11, further comprising:
a copying module configured to copy transaction records in the historical transaction data for each machine learning sub-model according to a copy number of transaction records determined by a weight Wₛ of each initial target variable yₛ, wherein the initial target variable yₛ is used to obtain the intermediate target variables; and
a sample module configured to use the copied historical transaction data as training samples of the machine learning sub-model.

16-18. (canceled)

19. A non-transitory computer-readable storage medium storing a set of instructions that is executable by one or more processors of an electronic device to cause the electronic device to perform a modeling method for a machine learning model, the method comprising:
training a plurality of machine learning sub-models to obtain a probability value for each of the machine learning sub-models;
obtaining a target probability value based on probability values obtained from the training of the plurality of machine learning sub-models; and
establishing, according to the target probability value and feature variables, a target machine learning model for determining a target behavior.

20. The non-transitory computer-readable storage medium of claim 19, wherein each of the plurality of machine learning sub-models corresponds to an intermediate target variable, and the set of instructions that is executable by the one or more processors of the electronic device causes the electronic device to further perform:
before training the plurality of the machine learning sub-models, merging compatible initial target variables to obtain the intermediate target variables according to compatible or mutually exclusive states among initial target variables, the intermediate target variables being in a mutually exclusive state, wherein at least one of the initial target variables is used to indicate an implementation form of the target behavior.

21. The non-transitory computer-readable storage medium of claim 20, the set of instructions that is executable by the one or more processors of the electronic device causes the electronic device to perform the following to merge merging the compatible initial target variables:
constructing an initial target variable pair for every two initial target variables in a mutually exclusive slate;
constructing a split set comprising the initial target variables;
for each initial target variable pair, splitting a split set into two next-level split sets according to the initial target variable pair, each of the next-level split sets comprising an initial target variable in the initial target variable pair and one or more elements in the split set, wherein the next-level split set is used for conducting splitting according to a next initial target variable pair;
merging split sets having a mutual inclusion relationship to obtain a target subset; and
merging initial target variables in the target subset to obtain at least one of the intermediate target variables.

22. The non-transitory computer-readable storage medium of claim 20, the set of instructions that is executable by the one or more processors of the electronic device causes the electronic device to further perform:
before merging the compatible initial target variables, determining compatible or mutually exclusive states between the initial target variables according to a formula:
$$\{ \begin{matrix}\frac{{Num}_{ij}}{{Num}_{i }} < {T}_{1} and \frac{{Num}_{ij}}{{Nim}_{j}} < {T}_{2} , & {H}_{ij} = 1 \\ Otherwise , & {H}_{ij} = 0\end{matrix}$$
wherein Numᵢⱼ is the number of transaction records defined as positive samples in historical transaction data by both an initial target variable yᵢ and an initial target variable yⱼ, Numᵢ is the number of transaction records defined as positive samples in the historical transaction data by initial target variable yᵢ, Numⱼ is the number of transaction records defined as positive samples in the historical transaction data by initial target variable yⱼ, 1≤i≤N, 1≤j≤N, N is the total number of initial feature variables, the two initial target variables are exclusive when H=1, the two initial target variables are compatible when H=0, T₁ and T₂ are preset thresholds, 0<T₁<1, and 0<T₂<1.

23. The non-transitory computer-readable storage medium of claim 20, wherein at least one of the machine learning sub-models is a linear model, and the set of instructions that is executable by the one or more processors of the electronic device causes the electronic device to further perform:
before training the plurality of machine learning sub-models, determining a covariance between a feature variable X_{q} and each initial target variable yₛ for the at least one of the machine learning sub-models, wherein the initial target variable yₛ is used to obtain the intermediate target variables; and
screening out the feature variable X_{q} if signs of the covariances between the feature variable X_{q} and each initial target variables yₛ are not the same and keeping the feature variable X_{q} if signs of the covariances between the feature variable X_{q} and each initial target variables yₛ are the same.

24. The non-transitory computer-readable storage medium of claim 20, wherein the set of instructions that is executable by the one or more processors of the electronic device causes the electronic device to further perform:
before training the plurality of machine learning sub-models, copying transaction records in the historical transaction data for each machine learning sub-model according to a copy number of transaction records determined by a weight Wₛ of each initial target variable yₛ, wherein the initial target variable yₛ is used to obtain the intermediate target variables; and
using the copied historical transaction data as training samples of the machine learning sub-model.

25-27. (canceled)
